(19) United States
(12) Patent Application Publication
(10) Pub. No.: US 2019/0263232 A1
(43) Pub. Date: Aug. 29, 2019

(54) Adjustable Polar Blind Assembly for a Window

(71) Applicant: Deep View, LLC, Bellingham, WA (US)

(72) Inventors: Lo I YIN, Silver Spring, MD (US); Won Ok YIN, Silver Spring, MD (US); Way YIN, Bellingham, WA (US); Hwei YIN, Ft. Collins, CO (US)

(21) Appl. No.: 15/908,540

(22) Filed: Feb. 28, 2018

(51) Int. Cl. B60J 3/06; B60J 1/20

(52) U.S. Cl. CPC B60J 3/06; B60J 1/2041; B60J 1/2019; B60J 1/2016

(57) ABSTRACT

An adjustable polar blind assembly for window includes a 90-degrees polarization filter, an adjustable shade unit, a 0-degrees polarization filter. The 90-degrees polarization filter, which is positioned adjacent to a window, is mounted offset of the adjustable shade unit. The 0-degrees polarization filter is mounted offset of the adjustable shade unit, opposite of the 90-degrees polarization filter. Moreover, the angles of polarization for the 0-degrees polarization filter and the 90-degrees polarization filter are oriented perpendicular to one another. The adjustable shade unit includes a retractable roller mechanism, a 45-degrees polarization filter, and a transparent filter. The 45-degrees polarization filter that has an angle of polarization of 45 degrees relative to the perpendicularly oriented filters is connected to the retractable roller mechanism by the transparent filter. The 45-degrees polarization filter is in optical communication with the perpendicularly oriented filters to provide different light intensities within the adjustable polar blind assembly.

### FIELD OF THE INVENTION

The present invention relates generally to field of window shades. More specifically, the present invention is an adjustable polar blind assembly that utilizes multiple polarization filters to control the variable intensities of the transmitted light of a window.

### BACKGROUND OF THE INVENTION

A window blind is a type of window covering that is normally installed from the inside of the building structure. There are many different kinds of window blinds which use a variety of control systems. A typical window blind is made up of several long horizontal or vertical slats of various types of hard material, including wood, plastic or metal which are held together by cords that run through the blind slats. However, window blinds can also be made from fabric material or any other types of flexible material that can extend and retract. Generally, window blinds can be maneuvered with either a manual controller or a remote-control unit by managing them in between an opened position and a closed position as the hard or flexible material block out most of the light. Since the existing window blinds only operate in between the opened position and the closed position, users do not get to control amount of light that is transmitted along the length of the existing window blinds.

It is therefore an objective of the present invention to provide an adjustable polar blind assembly for a window. More specifically, the present invention utilizes two sheets of polarization filters whose angles of polarization are oriented perpendicular to one another with an adjustable shade unit whose angle of polarization is 45 degrees relative to perpendicularly oriented polarization filters so that the transmitting light intensity can be varied from a maximum value to a minimum value, essentially zero. As a result, one can effectively block out a high intensity light source such as the sun or control the amount of brightness of the high intensity light source through the operation of the adjustable shade unit. Due to the configuration of the adjustable shade unit, the present invention can vary the amount of transmitted light along different sections of the adjustable polar blind assembly.

### BRIEF DESCRIPTION OF THE DRAWINGS

FIG. 1 is a front perspective view of the present invention.

FIG. 2 is a rear perspective view of the present invention.

FIG. 3 is a front perspective view the adjustable shade unit of the present invention.

FIG. 4 is a schematic view showing the first configuration for the preferred embodiment of the present invention.

FIG. 5 is a schematic view showing the second configuration for the preferred embodiment of the present invention.

FIG. 6 is a schematic view showing the third configuration for the preferred embodiment of the present invention.

FIG. 7 is a schematic view showing the first configuration for the alternative embodiment of the present invention.

FIG. 8 is a schematic view showing the second configuration for the alternative embodiment of the present invention.

FIG. 9 is a schematic view showing the third configuration for the alternative embodiment of the present invention.

FIG. 10 is a schematic view showing the fourth configuration for the alternative embodiment of the present invention.

FIG. 11 is a schematic view showing the fifth configuration for the alternative embodiment of the present invention.

FIG. 12 is a schematic view showing the sixth configuration for the alternative embodiment of the present invention.

FIG. 13 is a schematic view showing the seventh configuration for the alternative embodiment of the present invention.

FIG. 14 is a schematic view showing the eighth configuration for the alternative embodiment of the present invention.

FIG. 15 is a schematic view showing the ninth configuration for the alternative embodiment of the present invention.

FIG. 16 is a schematic view showing the tenth configuration for the alternative embodiment of the present invention.

FIG. 17 is a schematic view showing the eleventh configuration for the alternative embodiment of the present invention.

FIG. 18 is a schematic view showing the twelfth configuration for the alternative embodiment of the present invention.

FIG. 19 is a schematic view showing the thirteenth configuration for the alternative embodiment of the present invention.

FIG. 20 is a schematic view showing the fourteenth configuration for the alternative embodiment of the present invention.

FIG. 21 is a schematic view showing the fifteenth configuration for the alternative embodiment of the present invention.

### DETAIL DESCRIPTIONS OF THE INVENTION

All illustrations of the drawings are for the purpose of describing selected versions of the present invention and are not intended to limit the scope of the present invention.

The present invention is an adjustable polar blind assembly for a window so that the present invention is able to control the intensity of transmitting light. The present invention can vary incoming light over different sections as each section is defined by different configuration of the present invention. This is accomplished by utilizing three polarizing sheets in layers in which the middle layer can be raised and lowered upon user discretion. More specifically, a first polarizing sheet is vertically polarized, and a second polarizing sheet is horizontally polarized, although these can be interchanged. A third polarizing sheet is diagonally, at a 45-degree angle, polarized in comparison to the first polarizing sheet and the second polarizing sheet. Due to the multiple configurations, the present invention is able to provide different sections that corresponds with different light intensities. Even though the present invention is described in relation to the window blind, the primary concept behind the present invention can be implemented to automobile glasses, protective eye wears, decorative glasses, and other types of industry that may require ability to control the intensities of transmitting light.

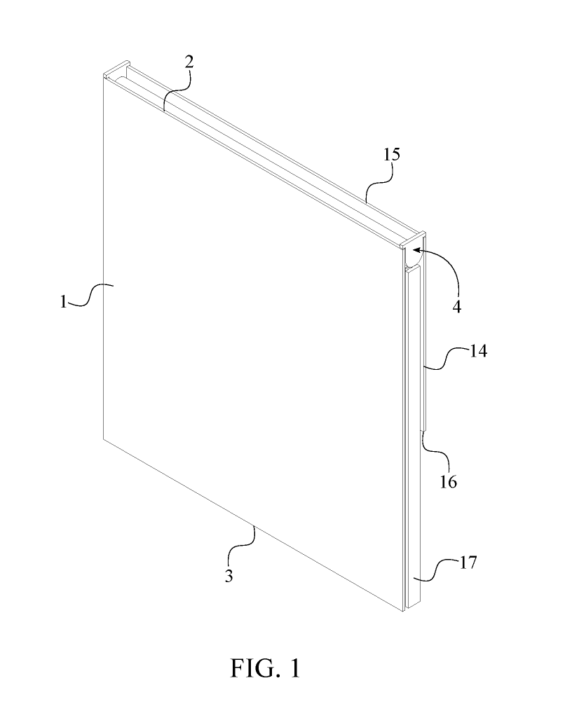

In reference to FIG. 1-3, the present invention comprises a 90-degrees polarization filter 1, an adjustable shade unit 4, and a 0-degrees polarization filter 14 in order to control the brightness of high intensity light source that transmitted through a window. The vertically polarized sheet is hereinafter identified as the 90-degrees polarization filter 1, and the horizontally polarized sheet is hereinafter identified as the 0-degrees polarization filter 14. The present invention is mounted behind the window so that an operator of the present invention can easily access and operate the adjustable shade unit 4 that comprises a retractable roller mechanism 5, a flexible sheet 6, and a weighted base 13 to attain different light intensity configurations within a building structure. In reference to the general configuration of the present invention, the retractable roller mechanism 5 is terminally connected across the flexible sheet 6. The weighted base 13 is terminally connected across the flexible sheet 6 and positioned opposite of the retractable roller mechanism 5. The 90-degrees polarization filter 1 is mounted offset of the adjustable shade unit 4 and positioned adjacent to the window. The 0-degrees polarization filter 14 is mounted offset of the adjustable shade unit 4 and positioned opposite of the 90-degrees polarization filter 1. Resultantly, the flexible sheet 6 is in optical communication with the 90-degrees polarization filter 1 and the 0-degrees polarization filter 14 by the retractable roller mechanism 5 and the weighted base 13 in order to attain the different light intensity configurations. In a preferred embodiment of the present invention, the flexible sheet 6 moves in and out of the retractable roller mechanism 5 through the operation of the adjustable shade unit 4 while the 90-degrees polarization filter 1 and the 0-degrees polarization filter 14 maintain a stationary position.

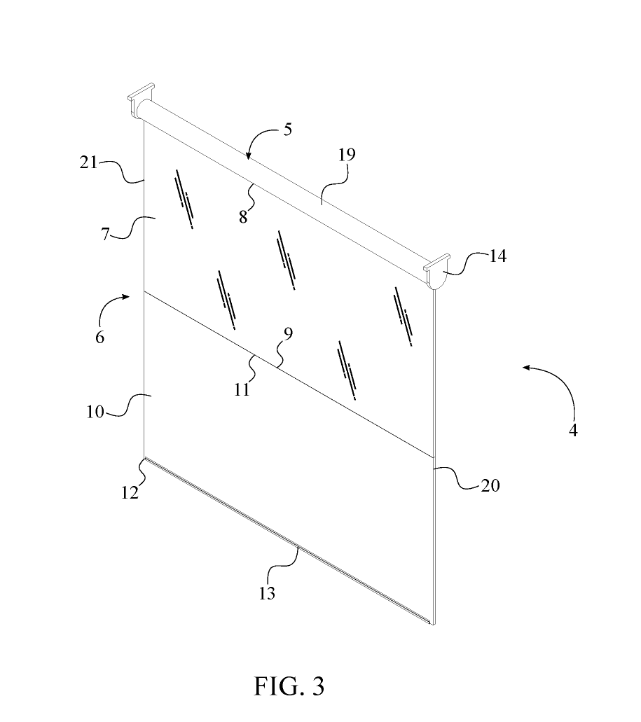

In reference to FIG. 3, the retractable roller mechanism 5 enables the operator to selectively position the flexible sheet 6 in between the 90-degrees polarization filter 1 and the 0-degrees polarization filter 14. The retractable roller mechanism 5 comprises a spool 19, pair of idle brackets, and a rotor unit so that the retractable roller mechanism 5 is able to control the height of the flexible sheet 6. More specifically, the spool 19 is mounted behind the window through the pair of idle brackets so that the spool 19 is able to provide surface area for the flexible sheet 6 to be encircled. The spool 19 is mechanically coupled with the rotor unit so that the rotor unit can coil or uncoil the spool 19 thus controlling the height of the flexible sheet 6. The rotor unit can be powered through a chain, a spring mechanism, an electrical motor, or any other types of operating mechanisms that are easy to operate. The weighted base 13 is a rigid structure and pulls down on the flexible sheet 6 due to gravitational force. Resultantly, the flexible sheet 6 can maintain a flat surface area in between the 90-degrees polarization filter 1 and the 0-degrees polarization filter 14. In order to access the maximum height of the flexible sheet 6, the flexible sheet 6 is terminally connected to the spool 19 and weighted base 13 as the height of the flexible sheet 6 measured between the weighted base 13 and the spool 19.

Due to the movement and the configuration of the adjustable shade unit 4 of the preferred embodiment, the adjustable shade unit 4 is able to attain different light intensity configuration within the preferred embodiment. In reference to FIG. 3, the flexible sheet 6 comprises a 45-degrees polarization filter 10 and a transparent filter 7 as the diagonally polarized sheet is hereinafter identified as the 45-degrees polarization filter 10. More specifically, a top edge 8 of the transparent filter 7 is terminally connected across the spool 19 of the retractable roller mechanism 5. A bottom edge 9 of the transparent filter 7 and a top edge 11 of the 45-degrees polarization filter 10 are terminally connected to each other and positioned opposite of the retractable roller mechanism 5. A bottom edge 12 of the 45-degrees polarization filter 10 is terminally connected across the weighted base 13. In other words, the transparent filter 7 downwardly extends from the retractable roller mechanism 5 to the 45-degrees polarization filter 10. The 45-degrees polarization filter 10 upwardly extends from the weighted base 13 to the transparent filter 7. Resultantly, the 45-degrees polarization filter 10 and the transparent filter 7 are connected to each other at the halfway mark of the flexible sheet 6, wherein the height ratio for the 45-degrees polarization filter 10 and the transparent filter 7 is 1:1. Furthermore, the transparent filter 7 and the 45-degrees polarization filter 10 each comprises an upper section 24 and a lower section 25 as the upper section 24 is adjacently positioned to the lower section 25 with respect to the transparent filter 7 and the 45-degrees polarization filter 10. The upper section 24 and the lower section 25 of the present invention are not exact sections within each respective filter and hereinafter considered as positional sections relative to the 90-degrees polarization filter 1 and the 0-degrees polarization filter 14 for detailed explanations of different configurations of the present invention.

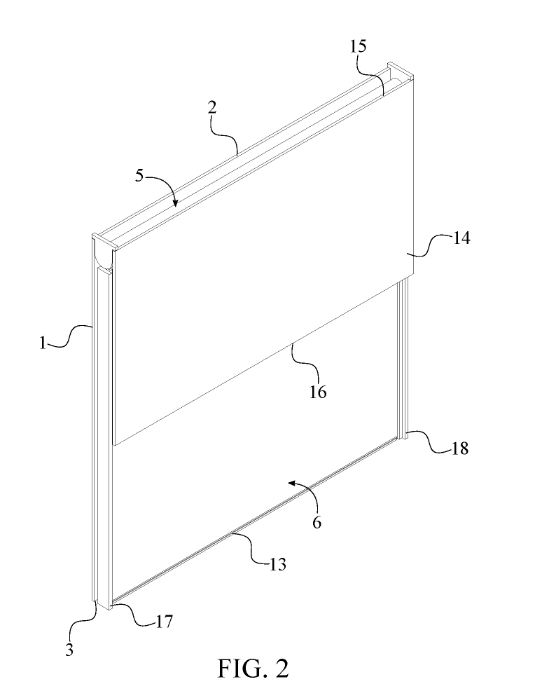

Due to the stationary position of the 90-degrees polarization filter 1 and the 0-degrees polarization filter 14 of the preferred embodiment, the adjustable shade unit 4 is able to attain three different light intensity configurations within the preferred embodiment. In reference to FIG. 1-2, a top edge 2 of the 90-degrees polarization filter 1 and a top edge 15 of the 0-degrees polarization filter 14 are coplanar to each other in such a way that the top edge 2 of the 90-degrees polarization filter 1 and the top edge 15 of the 0-degrees polarization filter 14 are positioned adjacent to the retractable roller mechanism 5. A bottom edge 3 of the 90-degrees polarization filter 1 and a bottom edge 16 of the 0-degrees polarization filter 14 are offset of each other such that the bottom edge 16 of the 0-degrees polarization filter 14 is centrally positioned in between the top edge 2 and the bottom edge 3 of the 90-degrees polarization filter 1. In other words, the height ratio for the 90-degrees polarization filter 1 and the flexible sheet 6 is 1:1. The height ratio for the 90-degrees polarization filter 1 and the 0-degrees polarization filter 14 is 2:1, respectively.

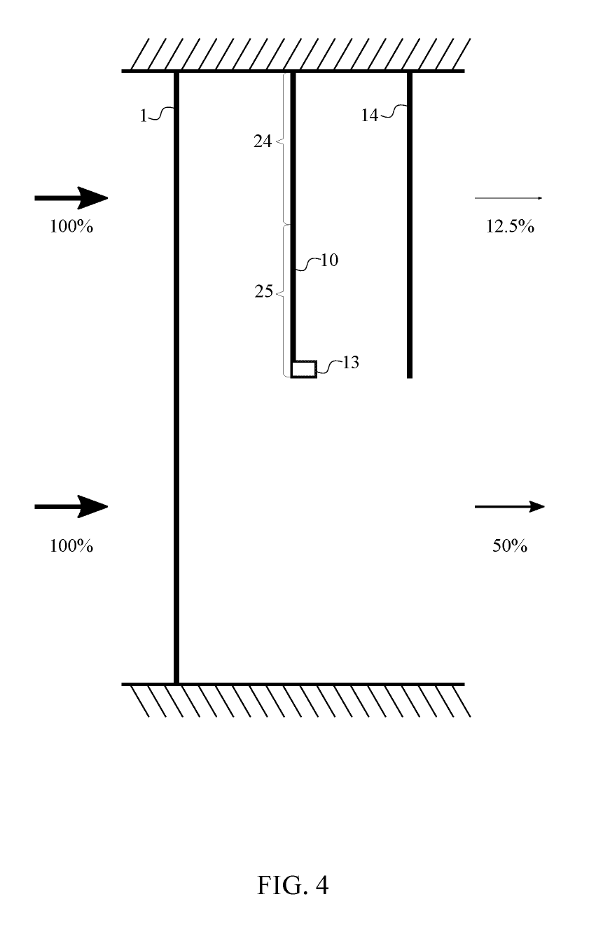

In reference to a first configuration of the preferred embodiment shown in FIG. 4, the 45-degrees polarization filter 10 is in optical communication with the 90-degrees polarization filter 1 and the 0-degrees polarization filter 14 by the retractable roller mechanism 5. The weighted base 13 is positioned adjacent to the bottom edge 16 of the 0-degrees polarization filter 14 thus completing the terminal connection between the weighted base 13 and the flexible sheet 6. More specifically, the transparent filter 7 is entirely encircled around the spool 19 of the retractable roller mechanism 5. The top edge 11 of the 45-degrees polarization filter 10 and the top edge 15 of the 0-degrees polarization filter 14 are positioned coplanar to each other about the retractable roller mechanism 5. Furthermore, the bottom edge 12 of the 45-degrees polarization filter 10 and the bottom edge 16 of the 0-degrees polarization filter 14 are positioned coplanar to each other. In other words, the 45-degrees polarization filter 10 positions behind an upper section of the 90-degrees polarization filter 1 and entirely in front of the 0-degrees polarization filter 14. Resultantly, the optical communication within the first configuration emits two different light intensities within the preferred embodiment. In reference to a first light intensity for the first configuration of the preferred embodiment, a light transmission of 12.5% emits through the 90-degrees polarization filter 1, the 45-degrees polarization filter 10, and the 0-degrees polarization filter 14. In reference to a second light intensity for the first configuration of the preferred embodiment, a light transmission of 50% emits only through a lower section of the 90-degrees polarization filter 1.

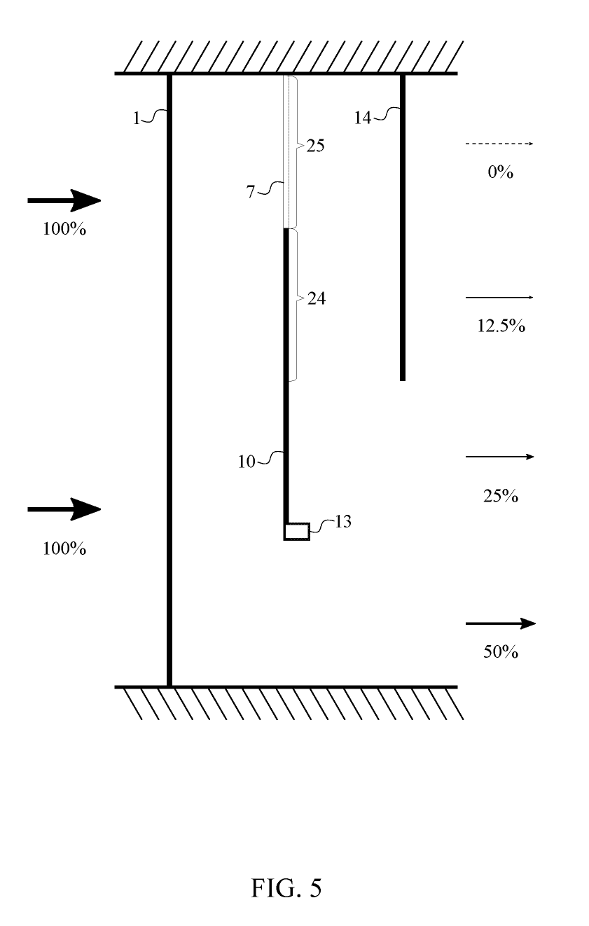

In reference to a second configuration of the preferred embodiment shown in FIG. 5, the transparent filter 7 is in optical communication with the 90-degrees polarization filter 1 and the 0-degrees polarization filter 14 by the retractable roller mechanism 5. The upper section 24 of the 45-degrees polarization filter 10 is in optical communication with the 90-degrees polarization filter 1 and 0-degrees polarization filter 14 by the retractable roller mechanism 5. The lower section 25 of the 45-degrees polarization filter 10 is in optical communication with the 90-degrees polarization filter 1 and 0-degrees polarization filter 14 by the retractable roller mechanism 5. The weighted base 13 is centrally positioned in between the bottom edge 16 of the 0-degrees polarization filter 14 and the bottom edge of 90-degrees polarization filter 1 thus completing the terminal connection between the weighted base 13 and the flexible sheet 6. More specifically, the transparent filter 7 is partially encircled around the spool 19 of the retractable roller mechanism 5. The top edge 11 of the 45-degrees polarization filter 10 is positioned in between the top edge 15 and the bottom edge 16 of the 0-degrees polarization filter 14 as the transparent filter 7 partially extends in between the top edge 11 of the 45-degrees polarization filter 10 and the spool 19 of the retractable roller mechanism 5. Furthermore, the bottom edge 12 of the 45-degrees polarization filter 10 is positioned in between the bottom edge 16 of the 0-degrees polarization filter 14 and the bottom edge 3 of the 90-degrees polarization filter 1. In other words, the lower section 25 of the transparent filter 7 positions behind the upper section of the 90-degrees polarization filter 1 and in front of an upper section of the 0-degrees polarization filter 14. The upper section 24 of the 45-degrees polarization filter 10 positions behind the upper section of the 90-degrees polarization filter 1 and in front of a lower section of the 0-degrees polarization filter 14. The lower section 25 of the 45-degrees polarization filter 10 positions behind the lower section of the 90-degrees polarization filter 1 and below the bottom edge 16 of the 0-degrees polarization filter 14. Resultantly, the optical communication within the second configuration emits four different light intensities within the preferred embodiment. In reference to a first light intensity for the second configuration of the preferred embodiment, a light transmission of 0% emits through the upper section of the 90-degrees polarization filter 1, the lower section 25 of the transparent filter 7, and the upper section of the 0-degrees polarization filter 14. In reference to a second light intensity for the second configuration of the preferred embodiment, a light transmission of 12.5% emits through the upper section of the 90-degrees polarization filter 1, the upper section 24 of the 45-degrees polarization filter 10, and the lower section of the 0-degrees polarization filter 14. In reference to a third light intensity for the second configuration of the preferred embodiment, a light transmission of 25% emits through the lower section of the 90-degrees polarization filter 1 and the lower section 25 of the 45-degrees polarization filter 10. In reference to a fourth light intensity for the second configuration of the preferred embodiment, a light transmission of 50% emits only through the lower section of the 90-degrees polarization filter 1.

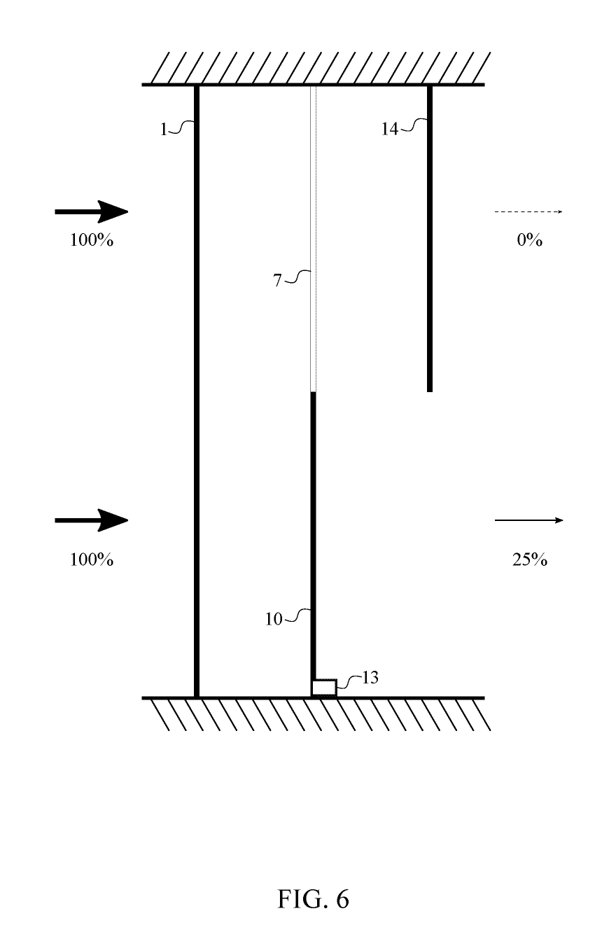

In reference to a third configuration of the preferred embodiment shown in FIG. 6, the transparent filter 7 is in optical communication with the 90-degrees polarization filter 1 and the 0-degrees polarization filter 14 by the retractable roller mechanism 5. The 45-degrees polarization filter 10 is in optical communication with the 90-degrees polarization filter 1 by the retractable roller mechanism 5. The weighted base 13 is positioned adjacent to the bottom edge 3 of the 90-degrees polarization filter 1 thus completing the terminal connection between the weighted base 13 and the flexible sheet 6. More specifically, the top edge 8 of the transparent filter 7 and the top edge 15 of the 0-degrees polarization filter 14 are positioned coplanar to each other. The bottom edge 9 of the transparent filter 7 and the bottom edge 16 of the 0-degrees polarization filter 14 are positioned coplanar to each other. The top edge 11 of the 45-degrees polarization filter 10 and the bottom edge 16 of the 0-degrees polarization filter 14 are positioned coplanar to each other. The bottom edge 12 of the 45-degrees polarization filter 10 and the bottom edge 3 of the 90-degrees polarization filter 1 are positioned coplanar to each other. In other words, the transparent filter 7 entirely positions behind the upper section of the 90-degrees polarization filter 1 and in front of the 0-degrees polarization filter 14. The 45-degrees polarization filter 10 entirely positions behind the lower section of the 90-degrees polarization filter 1 and below the bottom edge 16 of the 0-degrees polarization filter 14. Resultantly, the optical communication within the third configuration emits two different light intensities within the preferred embodiment. In reference to a first light intensity for the third configuration of the preferred embodiment, a light transmission of 0% emits through the upper section of the 90-degrees polarization filter 1, the transparent filter 7, and the 0-degrees polarization filter 14. In reference to a second light intensity for the third configuration of the preferred embodiment, a light transmission of 25% emits only through the lower section of the 90-degrees polarization filter 1 and the 45-degrees polarization filter 10.

The present invention further comprises a left track 17 and a right track 18 in order to maintain vertical movement for the flexible sheet 6 and weighted base 13. In reference to FIG. 1-3, the left track 17 and the right track 18 are perpendicularly positioned to the weighted base 13 and oppositely mounted of each other along the 90-degrees polarization filter 1. The weighted base 13 is positioned in between the left track 17 and the right track 18 during the operation of the adjustable shade unit 4. Additionally, a left lateral edge 20 of the flexible sheet 6 is engaged within the left track 17, and a right lateral edge 21 of the flexible sheet 6 is engaged within the right track 18. As a result, the flexible sheet 6 stays parallel with the 90-degrees polarization filter 1 and the 0-degrees polarization filter 14 during the operation of the adjustable shade unit 4 thus outputting the different light intensities.

In an alternative embodiment of the present invention that introduces the duel retractable for polar blind assembly for a window, the 0-degrees polarization filter 14 maintain a stationary position while the adjustable shade unit 4 and the 90-degrees polarization filter 1 are configured to achieve multiple configurations. More specifically, the flexible sheet 6 moves in and out of the retractable roller mechanism 5 through the operation of the adjustable shade unit 4, same as the preferred embodiment. However, the 90-degrees polarization filter 1 also moves in and out of a second retractable roller mechanism of alternative embodiment as the second retractable roller mechanism functions similar to the retractable roller mechanism 5 of the preferred embodiment.

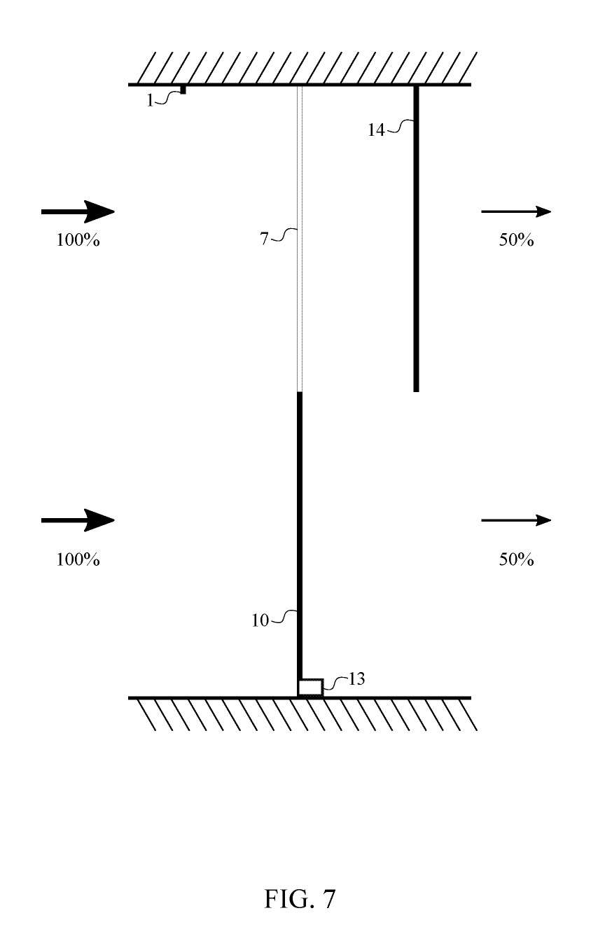

In reference to a first configuration of the alternative embodiment shown in FIG. 7, the 90-degrees polarization filter 1 is entirely encircled around the second retractable roller mechanism. The transparent filter 7 is in optical communication with the 0-degrees polarization filter 14 by the retractable roller mechanism 5 as the 45-degrees polarization filter 10 is positioned below the 0-degrees polarization filter 14. The weighted base 13 is positioned below the bottom edge 16 of the 0-degrees polarization filter 14 thus completing the terminal connection between the weighted base 13 and the flexible sheet 6. More specifically, the top edge 8 of the transparent filter 7 and the top edge 15 of the 0-degrees polarization filter 14 are positioned coplanar to each other. The bottom edge 9 of the transparent filter 7 and the bottom edge 16 of the 0-degrees polarization filter 14 are positioned coplanar to each other. The top edge 11 of the 45-degrees polarization filter 10 and the bottom edge 16 of the 0-degrees polarization filter 14 are positioned coplanar to each other. The bottom edge 12 of the 45-degrees polarization filter 10 is positioned offset of the 0-degrees polarization filter 14. In other words, the transparent filter 7 entirely positions in front of the 0-degrees polarization filter 14. The 45-degrees polarization filter 10 entirely positions below the bottom edge 16 of the 0-degrees polarization filter 14. Resultantly, the optical communication within the first configuration emits two different light intensities within the alternative embodiment. In reference to a first light intensity for the first configuration of the alternative embodiment, a light transmission of 50% emits through the transparent filter 7 and the 0-degrees polarization filter 14. In reference to a second light intensity for the first configuration of the alternative embodiment, a light transmission of 50% emits only through the 45-degrees polarization filter 10.

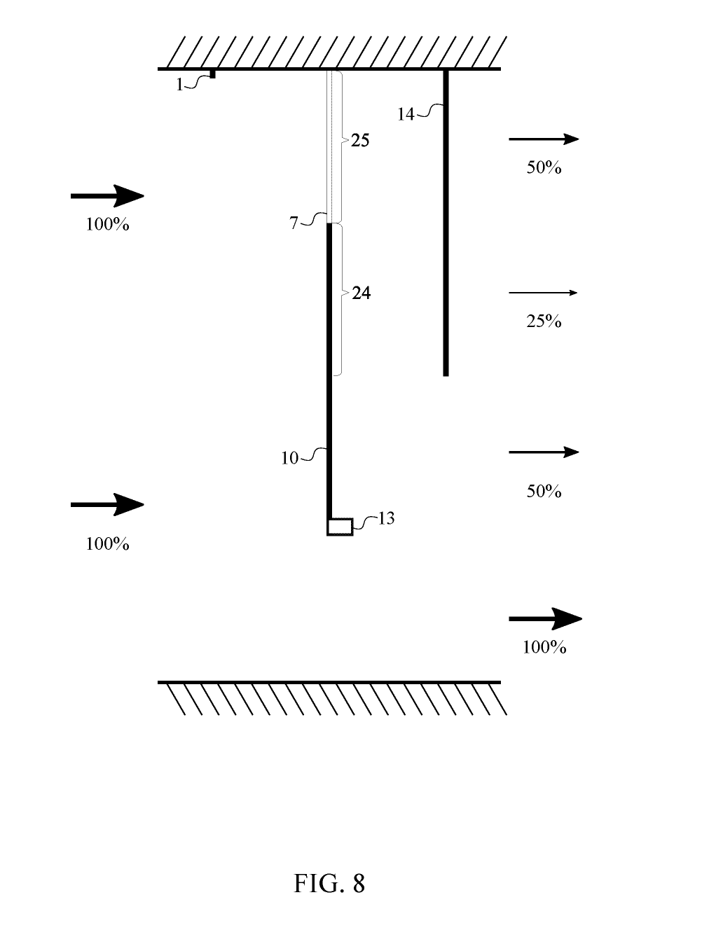

In reference to a second configuration of the alternative embodiment shown in FIG. 8, the 90-degrees polarization filter 1 is entirely encircled around the second retractable roller mechanism. The lower section 25 of the transparent filter 7 and the upper section 24 of the 45-degrees polarization filter 10 are in optical communication with the 0-degrees polarization filter 14 by the retractable roller mechanism 5. The weighted base 13 is positioned below the bottom edge 16 of the 0-degrees polarization filter 14 thus completing the terminal connection between the weighted base 13 and the flexible sheet 6. More specifically, the transparent filter 7 is partially encircled around the retractable roller mechanism 5. The top edge 11 of the 45-degrees polarization filter 10 is positioned in between the top edge 15 and the bottom edge 16 of the 0-degrees polarization filter 14 as the transparent filter 7 partially extends in between the top edge 11 of the 45-degrees polarization filter 10 and the retractable roller mechanism 5. Furthermore, the bottom edge 12 of the 45-degrees polarization filter 10 is positioned offset from the bottom edge 16 of the 0-degrees polarization filter 14. In other words, the lower section 25 of the transparent filter 7 positions in front of the upper section of the 0-degrees polarization filter 14. The upper section 24 of the 45-degrees polarization filter 10 positions in front of the lower section of the 0-degrees polarization filter 14. The lower section 25 of the 45-degrees polarization filter 10 positions below the bottom edge 16 of the 0-degrees polarization filter 14. Resultantly, the optical communication within the second configuration emits four different light intensities within the alternative embodiment. In reference to a first light intensity for the second configuration of the alternative embodiment, a light transmission of 50% emits through the lower section 25 of the transparent filter 7 and the upper section of the 0-degrees polarization filter 14. In reference to a second light intensity for the second configuration of the alternative embodiment, a light transmission of 25% emits through the upper section 24 of the 45-degrees polarization filter 10 and the lower section of the 0-degrees polarization filter 14. In reference to a third light intensity for the second configuration of the alternative embodiment, a light transmission of 50% emits through the lower section 25 of the 45-degrees polarization filter 10. In reference to a fourth light intensity for the second configuration of the alternative embodiment, a light transmission of 100% emits below the lower section 25 of the 45-degrees polarization filter 10.

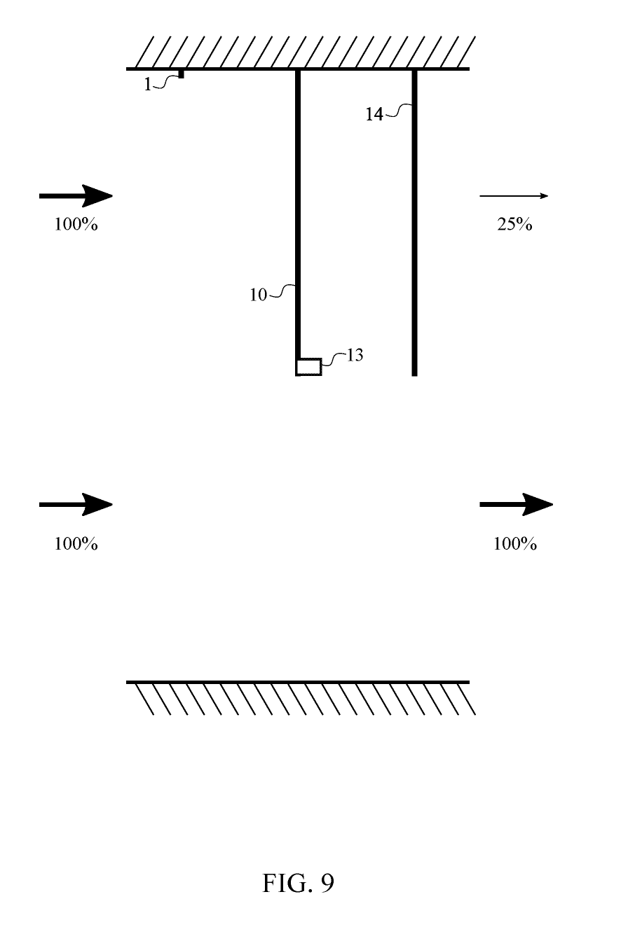

In reference to a third configuration of the alternative embodiment shown in FIG. 9, the 90-degrees polarization filter 1 is entirely encircled around the second retractable roller mechanism. The 45-degrees polarization filter 10 is in optical communication with the 0-degrees polarization filter 14 by the retractable roller mechanism 5. The weighted base 13 is positioned adjacent to the bottom edge 16 of the 0-degrees polarization filter 14 thus completing the terminal connection between the weighted base 13 and the flexible sheet 6. More specifically, the transparent filter 7 is entirely encircled around the retractable roller mechanism 5. The top edge 11 of the 45-degrees polarization filter 10 and the top edge 15 of the 0-degrees polarization filter 14 are positioned coplanar to each other about the retractable roller mechanism 5. Furthermore, the bottom edge 12 of the 45-degrees polarization filter 10 and the bottom edge 16 of the 0-degrees polarization filter 14 are positioned coplanar to each other. In other words, the 45-degrees polarization filter 10 positions entirely in front of the 0-degrees polarization filter 14. Resultantly, the optical communication within the third configuration emits two different light intensities within the alternative embodiment. In reference to a first light intensity for the third configuration of the alternative embodiment, a light transmission of 25% emits through the 45-degrees polarization filter 10 and the 0-degrees polarization filter 14. In reference to a second light intensity for the third configuration of the alternative embodiment, a light transmission of 100% emits below the 45-degrees polarization filter 10 and the 0-degrees polarization filter 14.

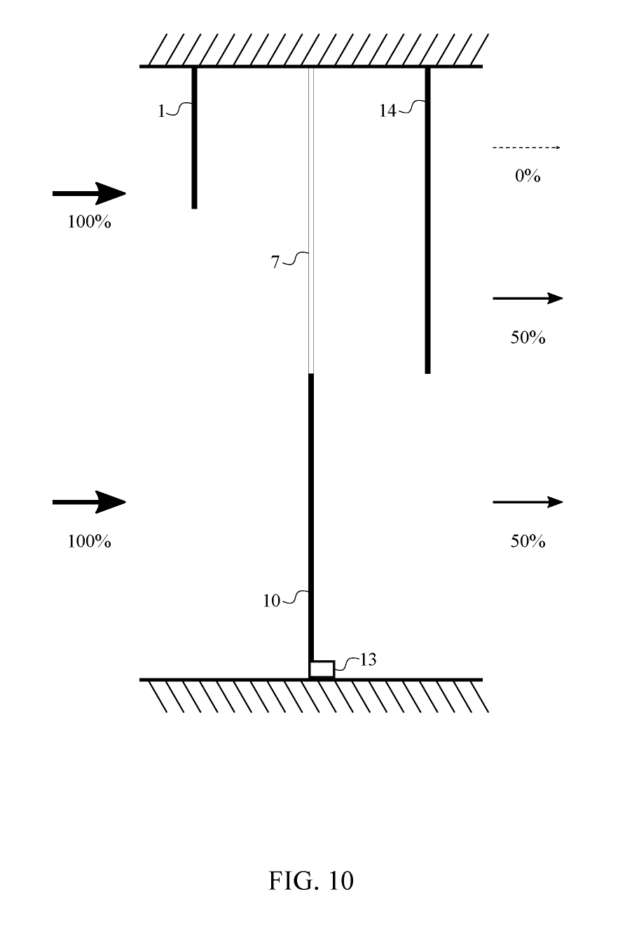

In reference to a fourth configuration of the alternative embodiment shown in FIG. 10, the 90-degrees polarization filter 1 is partially encircled around the second retractable roller mechanism thus partially covering the 0-degrees polarization filter 14. The upper section 24 of the transparent filter 7 is in optical communication with the 90-degrees polarization filter 1 and the upper section of the 0-degrees polarization filter 14 by the retractable roller mechanism 5. The lower section 25 of the transparent filter 7 is in optical communication with the upper section of the 0-degrees polarization filter 14 by the retractable roller mechanism 5. The 45-degrees polarization filter 10 is positioned below the 0-degrees polarization filter 14. The weighted base 13 is positioned below the bottom edge 16 of the 0-degrees polarization filter 14 thus completing the terminal connection between the weighted base 13 and the flexible sheet 6. More specifically, the bottom edge 3 of the 90-degrees polarization filter 1 is positioned in between the top edge 15 and the bottom edge 16 of the 0-degrees polarization filter 14. The top edge 8 of the transparent filter 7 and the top edge 15 of the 0-degrees polarization filter 14 are positioned coplanar to each other. The bottom edge 9 of the transparent filter 7 and the bottom edge 16 of the 0-degrees polarization filter 14 are positioned coplanar to each other. The top edge 11 of the 45-degrees polarization filter 10 and the bottom edge 16 of the 0-degrees polarization filter 14 are positioned coplanar to each other. The bottom edge 12 of the 45-degrees polarization filter 10 is positioned offset of the 0-degrees polarization filter 14. In other words, the transparent filter 7 entirely positions behind the 90-degrees polarization filter 1 and in front of the 0-degrees polarization filter 14. The 45-degrees polarization filter 10 entirely positions below the bottom edge 16 of the 0-degrees polarization filter 14. Resultantly, the optical communication within the fourth configuration emits three different light intensities within the alternative embodiment. In reference to a first light intensity for the fourth configuration of the alternative embodiment, a light transmission of 0% emits through the 90-degrees polarization filter 1, the upper section 24 of the transparent filter 7, and the upper section of the 0-degrees polarization filter 14. In reference to a second light intensity for the fourth configuration of the alternative embodiment, a light transmission of 50% emits through the lower section of the transparent filter 7 and the lower section of the 0-degrees polarization filter 14. In reference to a third light intensity for the fourth configuration of the alternative embodiment, a light transmission of 50% emits only through the 45-degrees polarization filter 10.

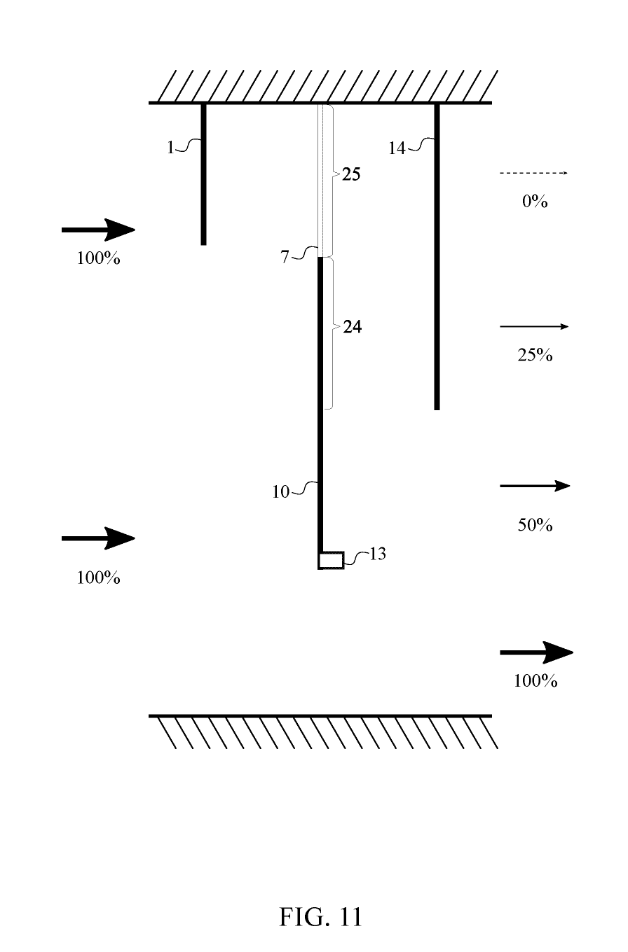

In reference to a fifth configuration of the alternative embodiment shown in FIG. 11, the 90-degrees polarization filter 1 is partially encircled around the second retractable roller mechanism thus partially covering the 0-degrees polarization filter 14. The lower section 25 of the transparent filter 7 is in optical communication with the 90-degrees polarization filter 1 and the upper section of the 0-degrees polarization filter 14 by the retractable roller mechanism 5. The upper section 25 of the 45-degrees polarization filter 10 is in optical communication with the lower section of the 0-degrees polarization filter 14 by the retractable roller mechanism 5. The weighted base 13 is positioned below the bottom edge 16 of the 0-degrees polarization filter 14 thus completing the terminal connection between the weighted base 13 and the flexible sheet 6. More specifically, the bottom edge 3 of the 90-degrees polarization filter 1 is positioned in between the top edge 15 and the bottom edge 16 of the 0-degrees polarization filter 14. The transparent filter 7 is partially encircled around the retractable roller mechanism 5. The top edge 11 of the 45-degrees polarization filter 10 is positioned in between the top edge 15 and the bottom edge 16 of the 0-degrees polarization filter 14 as the transparent filter 7 partially extends in between the top edge 11 of the 45-degrees polarization filter 10 and the retractable roller mechanism 5. Furthermore, the bottom edge 12 of the 45-degrees polarization filter 10 is positioned offset from the bottom edge 16 of the 0-degrees polarization filter 14. In other words, the lower section 25 of the transparent filter 7 positions behind the 90-degrees polarization filter 1 and in front of the upper section of the 0-degrees polarization filter 14. The upper section 24 of the 45-degrees polarization filter 10 positions in front of the lower section of the 0-degrees polarization filter 14. The lower section 25 of the 45-degrees polarization filter 10 positions below the bottom edge 16 of the 0-degrees polarization filter 14. Resultantly, the optical communication within the fifth configuration emits four different light intensities within the alternative embodiment. In reference to a first light intensity for the fifth configuration of the alternative embodiment, a light transmission of 0% emits through the 90-degrees polarization filter 1, the lower section 25 of the transparent filter 7, and the upper section of the 0-degrees polarization filter 14. In reference to a second light intensity for the fifth configuration of the alternative embodiment, a light transmission of 25% emits through the upper section 24 of the 45-degrees polarization filter 10 and the lower section of the 0-degrees polarization filter 14. In reference to a third light intensity for the fifth configuration of the alternative embodiment, a light transmission of 50% emits through the lower section 25 of the 45-degrees polarization filter 10. In reference to a fourth light intensity for the fifth configuration of the alternative embodiment n, a light transmission of 100% emits below the lower section 25 of the 45-degrees polarization filter 10.

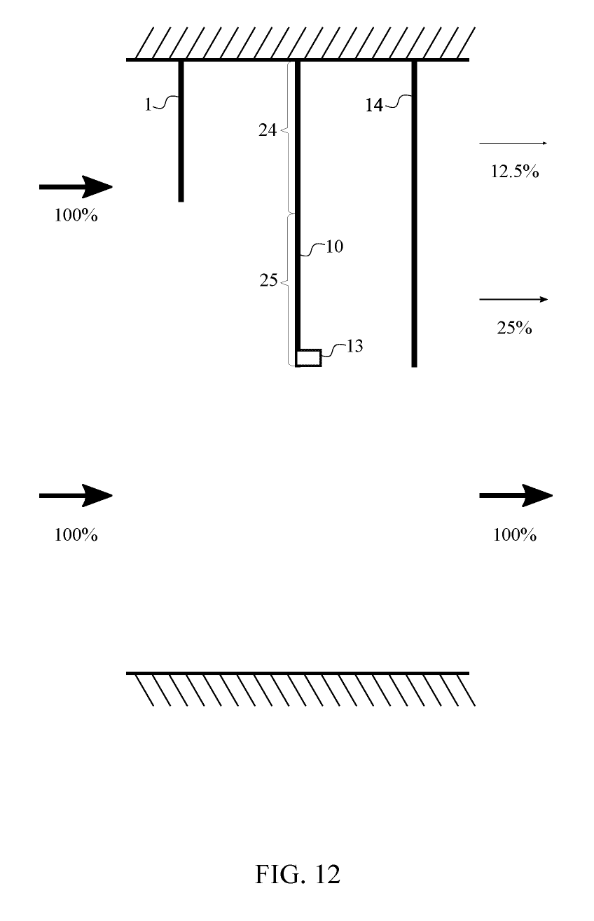

In reference to a sixth configuration of the alternative embodiment shown in FIG. 12, the 90-degrees polarization filter 1 is partially encircled around the second retractable roller mechanism thus partially covering the 0-degrees polarization filter 14. The 45-degrees polarization filter 10 is in optical communication with the 90-degrees polarization filter 1 and the 0-degrees polarization filter 14 by the retractable roller mechanism 5. The weighted base 13 is positioned adjacent to the bottom edge 16 of the 0-degrees polarization filter 14 thus completing the terminal connection between the weighted base 13 and the flexible sheet 6. More specifically, the transparent filter 7 is entirely encircled around the retractable roller mechanism 5. The bottom edge 3 of the 90-degrees polarization filter 1 is positioned in between the top edge 15 and the bottom edge 16 of the 0-degrees polarization filter 14. The top edge 11 of the 45-degrees polarization filter 10 and the top edge 15 of the 0-degrees polarization filter 14 are positioned coplanar to each other about the retractable roller mechanism 5. Furthermore, the bottom edge 12 of the 45-degrees polarization filter 10 and the bottom edge 16 of the 0-degrees polarization filter 14 are positioned coplanar to each other. In other words, the 45-degrees polarization filter 10 positions entirely behind the 90-degrees polarization filter 1 and in front of the 0-degrees polarization filter 14. Resultantly, the optical communication within the sixth configuration emits three different light intensities within the alternative embodiment. In reference to a first light intensity for the sixth configuration of the alternative embodiment, a light transmission of 12.5% emits through the 90-degrees polarization filter 1, the upper section 24 of the 45-degrees polarization filter 10 and the upper section of the 0-degrees polarization filter 14. In reference to a second light intensity for the sixth configuration of the alternative embodiment, a light transmission of 25% emits through the lower section 25 of the 45-degrees polarization filter 10 and the lower section of the 0-degrees polarization filter 14. In reference to a third light intensity for the sixth configuration of the alternative embodiment, a light transmission of 100% emits below the 45-degrees polarization filter 10 and the 0-degrees polarization filter 14.

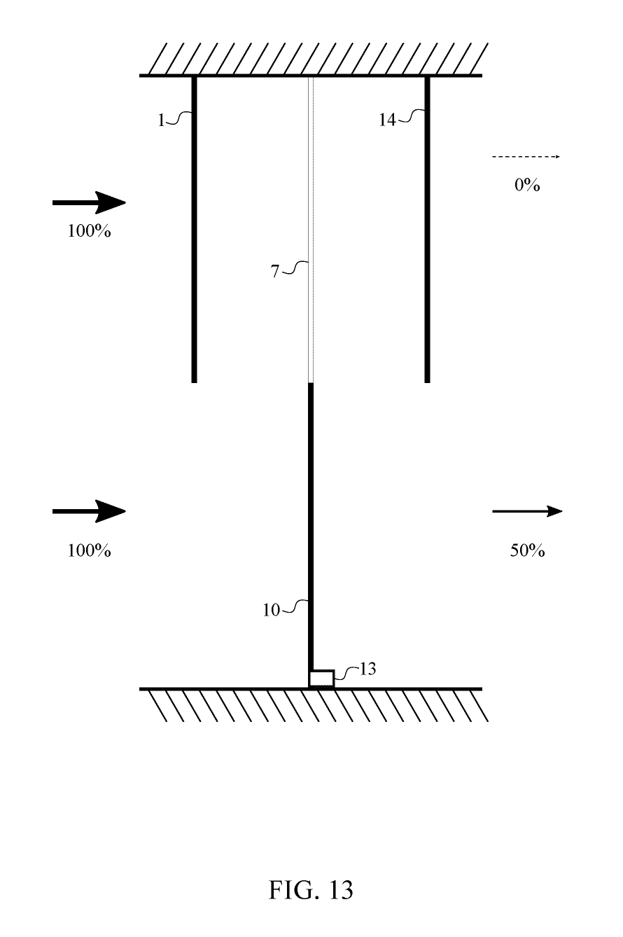

In reference to a seventh configuration of the alternative embodiment shown in FIG. 13, the 90-degrees polarization filter 1 is partially encircled around the second retractable roller mechanism thus fully covering the 0-degrees polarization filter 14. The transparent filter 7 is in optical communication with the 90-degrees polarization filter 1 and the 0-degrees polarization filter 14 by the retractable roller mechanism 5 as the 45-degrees polarization filter 10 is positioned below the 0-degrees polarization filter 14. The weighted base 13 is positioned below the bottom edge 16 of the 0-degrees polarization filter 14 thus completing the terminal connection between the weighted base 13 and the flexible sheet 6. More specifically, the bottom edge 3 of the 90-degrees polarization filter 1 is positioned coplanar with the bottom edge 16 of the 0-degrees polarization filter 14. The top edge 8 of the transparent filter 7 and the top edge 15 of the 0-degrees polarization filter 14 are positioned coplanar to each other. The bottom edge 9 of the transparent filter 7 and the bottom edge 16 of the 0-degrees polarization filter 14 are positioned coplanar to each other. The top edge 11 of the 45-degrees polarization filter 10 and the bottom edge 16 of the 0-degrees polarization filter 14 are positioned coplanar to each other. The bottom edge 12 of the 45-degrees polarization filter 10 is positioned offset of the 0-degrees polarization filter 14. In other words, the transparent filter 7 entirely positions behind the lower section of the 90-degrees polarization filter 1 and in front of the 0-degrees polarization filter 14. The 45-degrees polarization filter 10 entirely positions below the bottom edge 16 of the 0-degrees polarization filter 14 and the bottom edge 3 of the 90-degrees polarization filter 1. Resultantly, the optical communication within the seventh configuration emits two different light intensities within the alternative embodiment. In reference to a first light intensity for the seventh configuration of the alternative embodiment, a light transmission of 0% emits through the lower section of the 90-degrees polarization filter 1, the transparent filter 7, and the 0-degrees polarization filter 14. In reference to a second light intensity for the seventh configuration of the alternative embodiment, a light transmission of 50% emits only through the 45-degrees polarization filter 10.

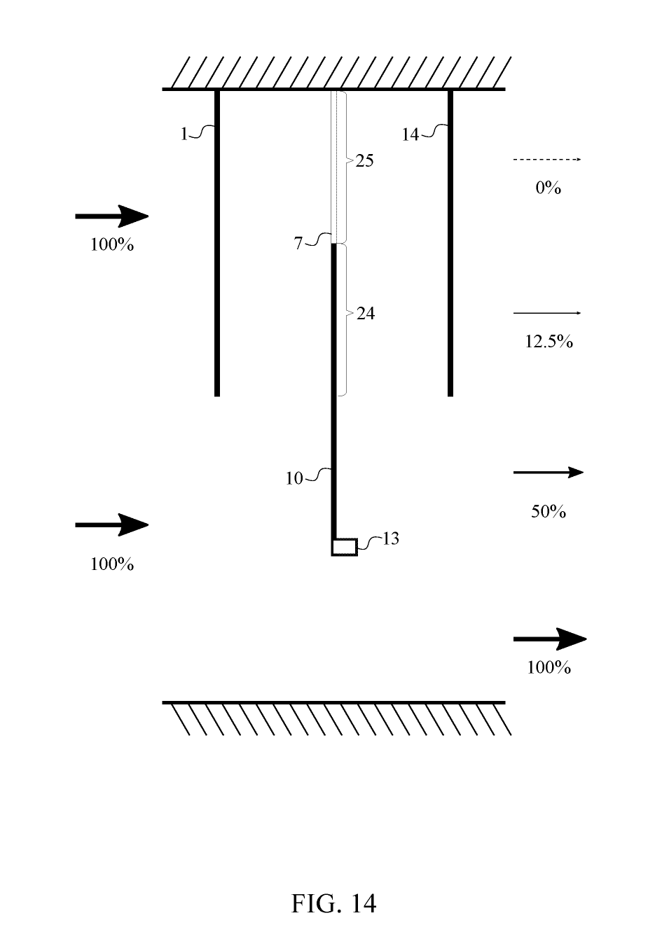

In reference to an eighth configuration of the alternative embodiment shown in FIG. 14, the 90-degrees polarization filter 1 is partially encircled around the second retractable roller mechanism thus fully covering the 0-degrees polarization filter 14. The lower section 25 of the transparent filter 7 and the upper section 24 of the 45-degrees polarization filter 10 are in optical communication with the 90-degrees polarization filter 1 and the 0-degrees polarization filter 14 by the retractable roller mechanism 5. The weighted base 13 is positioned below the bottom edge 16 of the 0-degrees polarization filter 14 thus completing the terminal connection between the weighted base 13 and the flexible sheet 6. More specifically, the bottom edge 3 of the 90-degrees polarization filter 1 is positioned coplanar with the bottom edge 16 of the 0-degrees polarization filter 14. The transparent filter 7 is partially encircled around the retractable roller mechanism 5. The top edge 11 of the 45-degrees polarization filter 10 is positioned in between the top edge 15 and the bottom edge 16 of the 0-degrees polarization filter 14 as the transparent filter 7 partially extends in between the top edge 11 of the 45-degrees polarization filter 10 and the retractable roller mechanism 5. Furthermore, the bottom edge 12 of the 45-degrees polarization filter 10 is positioned offset from the bottom edge 16 of the 0-degrees polarization filter 14. In other words, the lower section 25 of the transparent filter 7 positions behind the 90-degrees polarization filter 1 and in front of the upper section of the 0-degrees polarization filter 14. The upper section 24 of the 45-degrees polarization filter 10 positions behind the 90-degrees polarization filter 1 and in front of the lower section of the 0-degrees polarization filter 14. The lower section 25 of the 45-degrees polarization filter 10 positions below the bottom edge 16 of the 0-degrees polarization filter 14. Resultantly, the optical communication within the eighth configuration emits four different light intensities within the alternative embodiment. In reference to a first light intensity for the eighth configuration of the alternative embodiment, a light transmission of 0% emits through the 90-degrees polarization filter 1, the lower section 25 of the transparent filter 7, and the upper section of the 0-degrees polarization filter 14. In reference to a second light intensity for the eighth configuration of the alternative embodiment, a light transmission of 12.5% emits through the 90-degrees polarization filter 1, the upper section 24 of the 45-degrees polarization filter 10, and the lower section of the 0-degrees polarization filter 14. In reference to a third light intensity for the eighth configuration of the alternative embodiment, a light transmission of 50% emits through the lower section 25 of the 45-degrees polarization filter 10. In reference to a fourth light intensity for the eighth configuration of the alternative embodiment, a light transmission of 100% emits below the lower section 25 of the 45-degrees polarization filter 10.

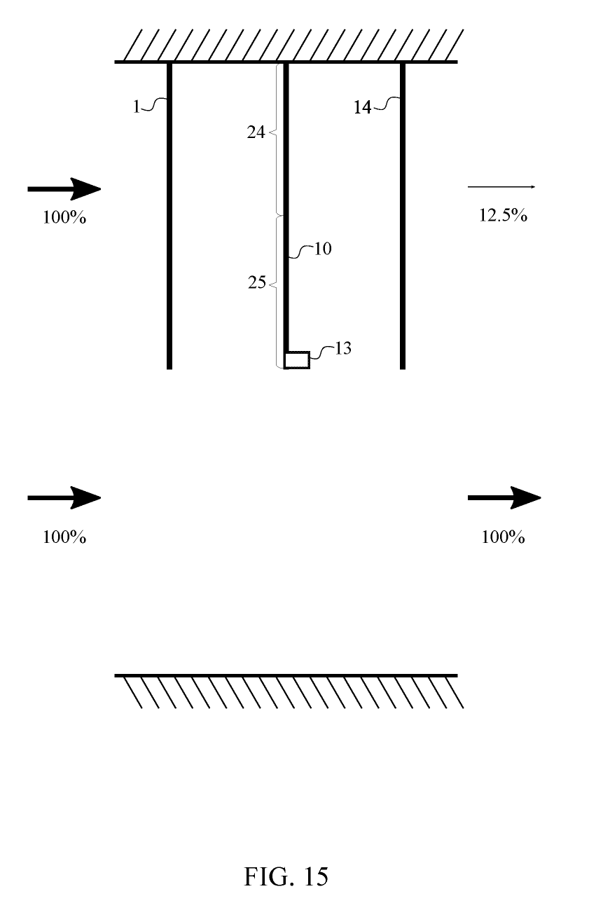

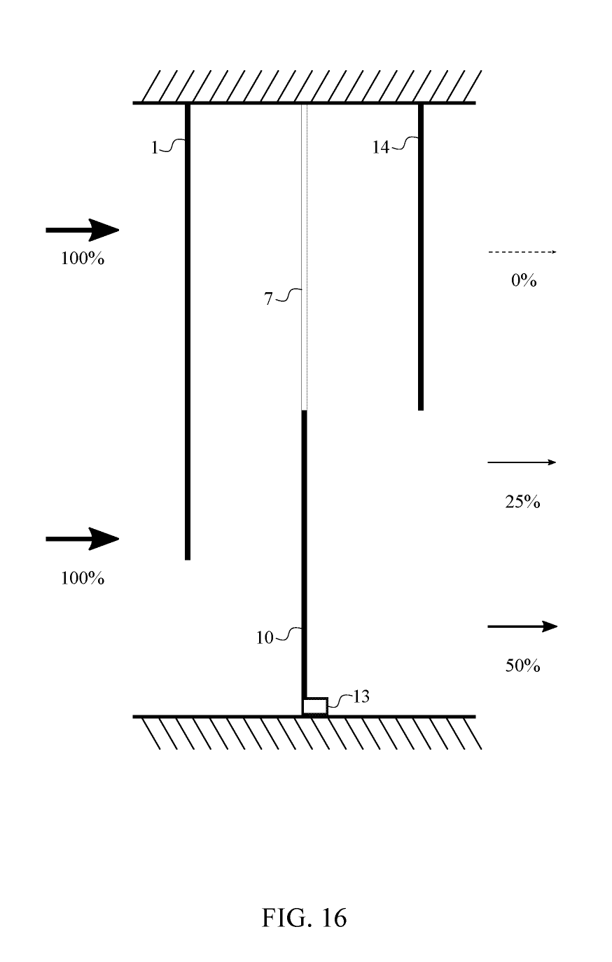

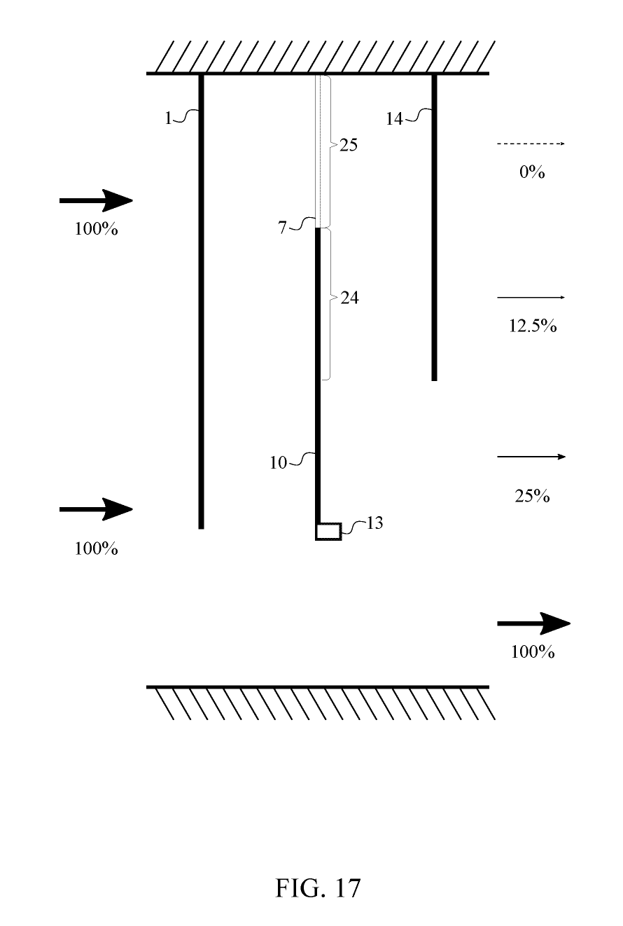

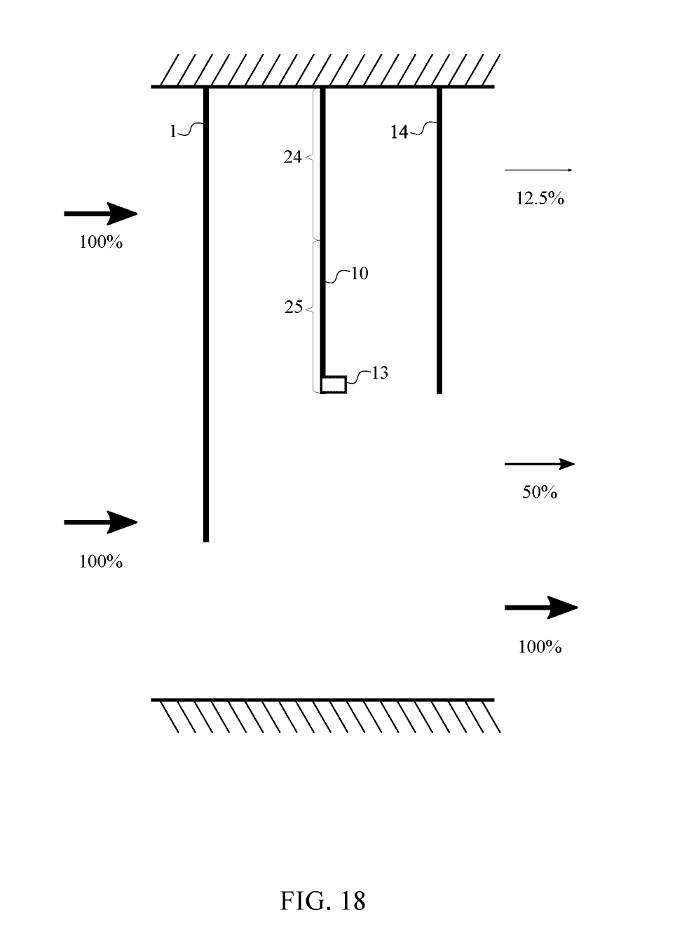

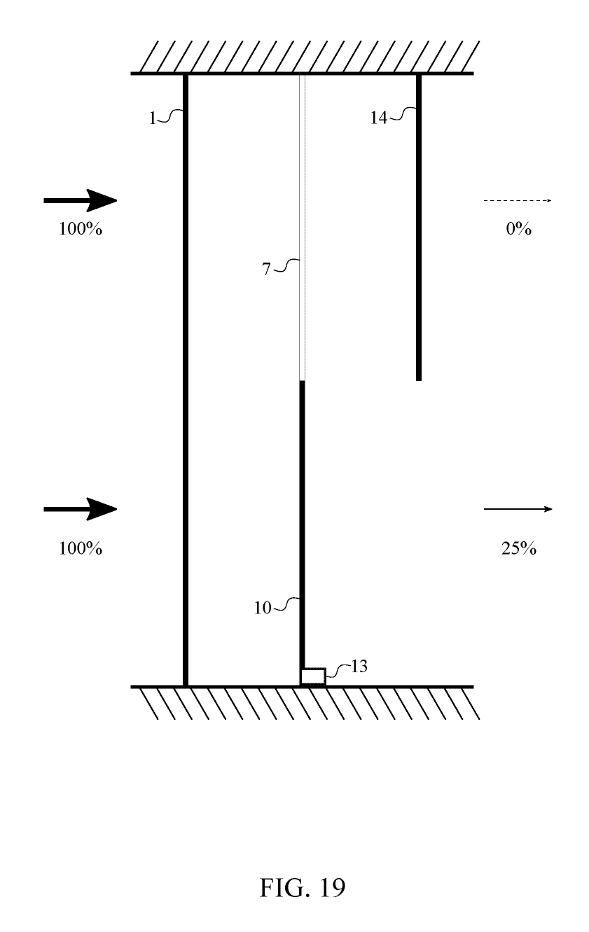

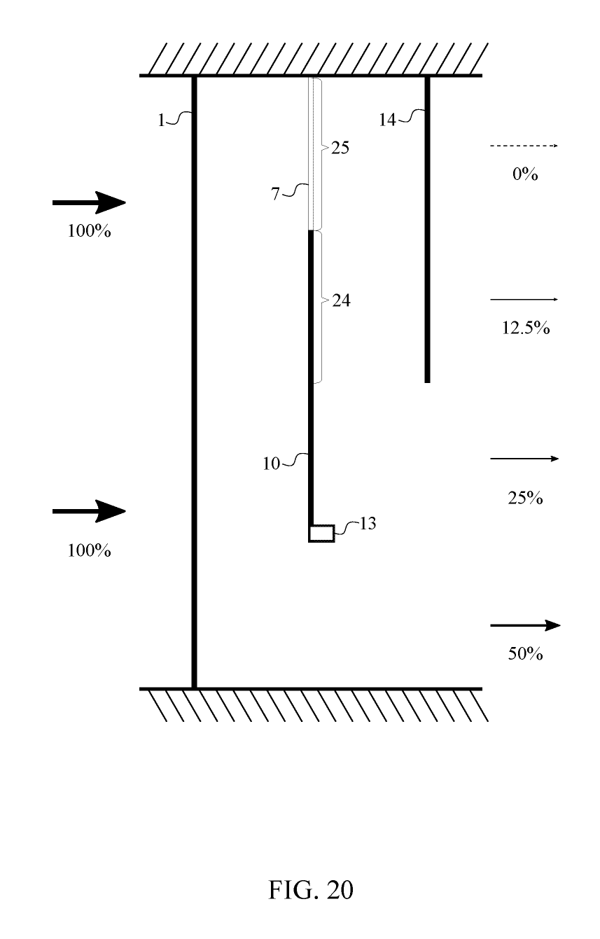

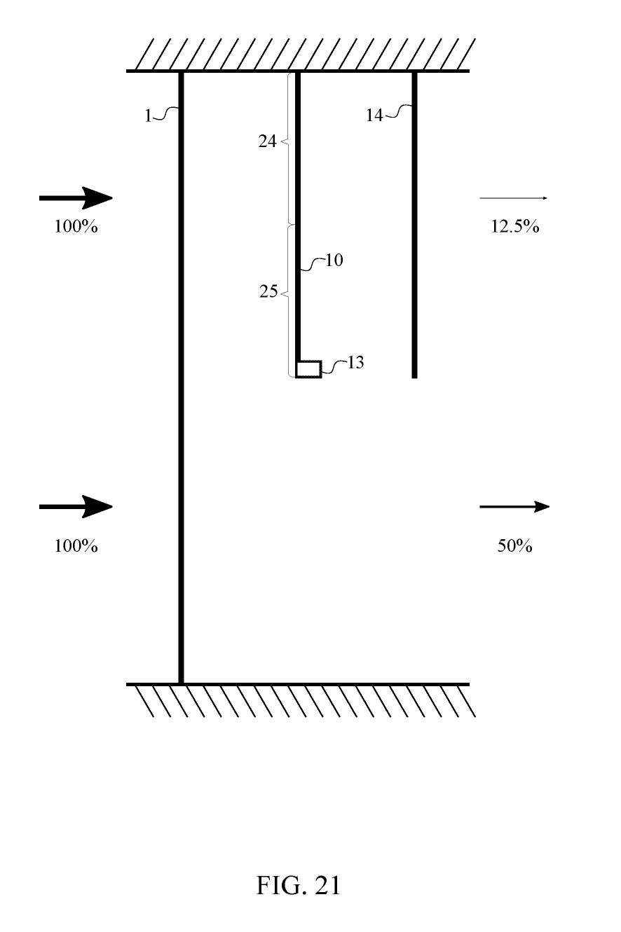

Additional configurations for the alternative embodiment are shown in FIG. 15-21. More specifically, these additional configurations allow different light intensities within the alternative embodiment as the 90-degrees polarization filter 1 is moved up and down and is in optical communication with multiple arrangements of the transparent filter 7 and the 45-degrees polarization filter 10.

The aforementioned light transmission percentages within the preferred embodiment and the alternative embodiment are listed as approximations can slightly vary within the present invention.

Although the invention has been explained in relation to its preferred embodiment, it is to be understood that many other possible modifications and variations can be made without departing from the spirit and scope of the invention as hereinafter claimed.

What is claimed is:

1. An adjustable polar blind assembly for a window comprises:
a 90-degrees polarization filter;
an adjustable shade unit;
a 0-degrees polarization filter;
the adjustable shade unit comprises a retractable roller mechanism, a flexible sheet, and a weighted base;
the retractable roller mechanism being terminally connected across the flexible sheet;
the weighted base being terminally connected across the flexible sheet, opposite of the retractable roller mechanism;
the 90-degrees polarization filter being mounted offset of the adjustable shade unit;
the 0-degrees polarization filter being mounted offset of the adjustable shade unit, opposite of the 90-degrees polarization filter; and
the flexible sheet being optical communication with the 90-degrees polarization filter and the 0-degrees polarization filter by the retractable roller mechanism and the weighted base.

2. The adjustable polar blind assembly for a window as claimed in claim 1 comprises:
the flexible sheet comprises a 45-degrees polarization filter and a transparent filter;
a top edge of the transparent filter being terminally connected across a spool of the retractable roller mechanism;
a bottom edge of the transparent filter and a top edge of the 45-degrees polarization filter being terminally connected to each other, opposite of the retractable roller mechanism; and
a bottom edge of the 45-degrees polarization filter being terminally connected across the weighted base.

3. The adjustable polar blind assembly for a window as claimed in claim 1 comprises:
a top edge of the 90-degrees polarization filter and a top edge of the 0-degrees polarization filter being coplanar to each other;
a bottom edge of the 90-degrees polarization filter and a bottom edge of the 0-degrees polarization filter being offset of each other; and
the bottom edge of the 0-degrees polarization filter being centrally positioned in between the top edge and the bottom edge of the 90-degrees polarization filter.

4. The adjustable polar blind assembly for a window as claimed in claim 1 comprises:
a 45-degrees polarization filter of the flexible sheet being optical communication with the 90-degrees polarization filter and the 0-degrees polarization filter by the retractable roller mechanism; and
the weighted base being positioned adjacent to a bottom edge of the 0-degrees polarization filter.

5. The adjustable polar blind assembly for a window as claimed in claim 4 comprises:
the transparent filter of the flexible sheet being entirely encircled around a spool of the retractable roller mechanism;
a top edge of the 45-degrees polarization filter and a top edge of the 0-degrees polarization filter being coplanar to each other; and
a bottom edge of the 45-degrees polarization filter and the bottom edge of the 0-degrees polarization filter being coplanar to each other.

6. The adjustable polar blind assembly for a window as claimed in claim 1 comprises:
a transparent filter and a 45-degrees polarization filter of the flexible sheet each comprises an upper section and a lower section;
the upper section being adjacently positioned to the lower section;
the transparent filter being optical communication with the 90-degrees polarization filter and the 0-degrees polarization filter by the retractable roller mechanism;
the upper section of the 45-degrees polarization filter being optical communication with the 90-degrees polarization filter and the 0-degrees polarization filter by the retractable roller mechanism;
the lower section of the 45-degrees polarization filter being optical communication with the 90-degrees polarization filter by the retractable roller mechanism; and
the weighted base being centrally positioned in between a bottom edge of the 0-degrees polarization filter and a bottom edge of the 90-degrees polarization filter.

7. The adjustable polar blind assembly for a window as claimed in claim 6 comprises:
the transparent filter being partially encircled around a spool of the retractable roller mechanism;
a top edge of the 45-degrees polarization filter being positioned in between a top edge and the bottom edge of the 0-degrees polarization filter; and
a bottom edge of the 45-degrees polarization filter being positioned in between the bottom edge of the 0-degrees polarization filter and the bottom edge of the 90-degrees polarization filter.

8. The adjustable polar blind assembly for a window as claimed in claim 1 comprises:
a transparent filter of the flexible sheet being optical communication with the 90-degrees polarization filter and the 0-degrees polarization filter by the retractable roller mechanism;
a 45-degrees polarization filter of the flexible sheet being optical communication with the 90-degrees polarization filter by the retractable roller mechanism; and
the weighted base being positioned adjacent to a bottom edge of the 90-degrees polarization filter.

9. The adjustable polar blind assembly for a window as claimed in claim 8 comprises:
a top edge of the transparent filter and a top edge of the 0-degrees polarization filter being coplanar to each other;
a bottom edge of the transparent filter and a bottom edge of the 0-degrees polarization filter being coplanar to each other;
a top edge of the 45-degrees polarization filter and the bottom edge of the 0-degrees polarization filter being coplanar to each other; and
a bottom edge of the 45-degrees polarization filter and the bottom edge of the 90-degrees polarization filter being coplanar to each other.

10. The adjustable polar blind assembly for a window as claimed in claim 8 comprises:
a left track;
a right track;
the left track and the right track being perpendicularly positioned to the weighted base;
the left track and the right track being oppositely mounted of each other along the 90-degrees polarization filter;
a left lateral edge of the flexible sheet being engaged within the left track; and
a right lateral edge of the flexible sheet being engaged within the right track.

11. An adjustable polar blind assembly for a window comprises:
a 90-degrees polarization filter;
an adjustable shade unit;
a 0-degrees polarization filter;
the adjustable shade unit comprises a retractable roller mechanism, a flexible sheet, and a weighted base;
the flexible sheet comprises a 45-degrees polarization filter and a transparent filter;
a top edge of the transparent filter being terminally connected across a spool of the retractable roller mechanism;
a bottom edge of the transparent filter and a top edge of the 45-degrees polarization filter being terminally connected to each other, opposite of the retractable roller mechanism;
a bottom edge of the 45-degrees polarization filter being terminally connected across the weighted base;
the 90-degrees polarization filter being mounted offset of the adjustable shade unit;
the 0-degrees polarization filter being mounted offset of the adjustable shade unit, opposite of the 90-degrees polarization filter; and
the flexible sheet being optical communication with the 90-degrees polarization filter and the 0-degrees polarization filter by the retractable roller mechanism and the weighted base.

12. The adjustable polar blind assembly for a window as claimed in claim 11 comprises:
a top edge of the 90-degrees polarization filter and a top edge of the 0-degrees polarization filter being coplanar to each other;
a bottom edge of the 90-degrees polarization filter and a bottom edge of the 0-degrees polarization filter being offset of each other; and
the bottom edge of the 0-degrees polarization filter being centrally positioned in between the top edge and the bottom edge of the 90-degrees polarization filter.

13. The adjustable polar blind assembly for a window as claimed in claim 11 comprises:
the transparent filter being entirely encircled around a spool of the retractable roller mechanism;
a top edge of the 45-degrees polarization filter and a top edge of the 0-degrees polarization filter being coplanar to each other;
a bottom edge of the 45-degrees polarization filter and the bottom edge of the 0-degrees polarization filter being coplanar to each other;
the 45-degrees polarization filter being optical communication with the 90-degrees polarization filter and the 0-degrees polarization filter by the retractable roller mechanism; and
the weighted base being positioned adjacent to a bottom edge of the 0-degrees polarization filter.

14. The adjustable polar blind assembly for a window as claimed in claim 11 comprises:
the transparent filter and the 45-degrees polarization filter each comprises an upper section and a lower section;
the transparent filter being partially encircled around a spool of the retractable roller mechanism;
a top edge of the 45-degrees polarization filter being positioned in between a top edge and the bottom edge of the 0-degrees polarization filter;
a bottom edge of the 45-degrees polarization filter being positioned in between the bottom edge of the 0-degrees polarization filter and the bottom edge of the 90-degrees polarization filter;
the upper section being adjacently positioned to the lower section;
the transparent filter being optical communication with the 90-degrees polarization filter and the 0-degrees polarization filter by the retractable roller mechanism;
the upper section of the 45-degrees polarization filter being optical communication with the 90-degrees polarization filter and the 0-degrees polarization filter by the retractable roller mechanism;
the lower section of the 45-degrees polarization filter being optical communication with the 90-degrees polarization filter by the retractable roller mechanism; and
the weighted base being centrally positioned in between a bottom edge of the 0-degrees polarization filter and a bottom edge of the 90-degrees polarization filter.

15. The adjustable polar blind assembly for a window as claimed in claim 11 comprises:
a top edge of the transparent filter and a top edge of the 0-degrees polarization filter being coplanar to each other;
a bottom edge of the transparent filter and a bottom edge of the 0-degrees polarization filter being coplanar to each other;
a top edge of the 45-degrees polarization filter and the bottom edge of the 0-degrees polarization filter being coplanar to each other;
a bottom edge of the 45-degrees polarization filter and the bottom edge of the 90-degrees polarization filter being coplanar to each other;
the transparent filter being optical communication with the 90-degrees polarization filter and the 0-degrees polarization filter by the retractable roller mechanism;
the 45-degrees polarization filter being optical communication with the 90-degrees polarization filter by the retractable roller mechanism; and
the weighted base being positioned adjacent to a bottom edge of the 90-degrees polarization filter.

16. The adjustable polar blind assembly for a window as claimed in claim 11 comprises:
a left track;
a right track;
the left track and the right track being perpendicularly positioned to the weighted base;
the left track and the right track being oppositely mounted of each other along the 90-degrees polarization filter;
a left lateral edge of the flexible sheet being engaged within the left track; and
a right lateral edge of the flexible sheet being engaged within the right track.

17. An adjustable polar blind assembly for a window comprises:
a 90-degrees polarization filter;
an adjustable shade unit;
a 0-degrees polarization filter;
a left track;
a right track;
the adjustable shade unit comprises a retractable roller mechanism, a flexible sheet, and a weighted base;
the flexible sheet comprises a 45-degrees polarization filter and a transparent filter;
a top edge of the transparent filter being terminally connected across a spool of the retractable roller mechanism;
a bottom edge of the transparent filter and a top edge of the 45-degrees polarization filter being terminally connected to each other, opposite of the retractable roller mechanism;
a bottom edge of the 45-degrees polarization filter being terminally connected across the weighted base;
the 90-degrees polarization filter being mounted offset of the adjustable shade unit;
the 0-degrees polarization filter being mounted offset of the adjustable shade unit, opposite of the 90-degrees polarization filter;
a top edge of the 90-degrees polarization filter and a top edge of the 0-degrees polarization filter being coplanar to each other;
a bottom edge of the 90-degrees polarization filter and a bottom edge of the 0-degrees polarization filter being offset of each other;
the bottom edge of the 0-degrees polarization filter being centrally positioned in between the top edge and the bottom edge of the 90-degrees polarization filter;
the flexible sheet being optical communication with the 90-degrees polarization filter and the 0-degrees polarization filter by the retractable roller mechanism and the weighted base;
the left track and the right track being perpendicularly positioned to the weighted base;
the left track and the right track being oppositely mounted of each other along the 90-degrees polarization filter;
a left lateral edge of the flexible sheet being engaged within the left track; and
a right lateral edge of the flexible sheet being engaged within the right track.

18. The adjustable polar blind assembly for a window as claimed in claim 17 comprises:
the transparent filter being entirely encircled around a spool of the retractable roller mechanism;
a top edge of the 45-degrees polarization filter and a top edge of the 0-degrees polarization filter being coplanar to each other;
a bottom edge of the 45-degrees polarization filter and the bottom edge of the 0-degrees polarization filter being coplanar to each other;
the 45-degrees polarization filter being optical communication with the 90-degrees polarization filter and the 0-degrees polarization filter by the retractable roller mechanism; and
the weighted base being positioned adjacent to a bottom edge of the 0-degrees polarization filter.

19. The adjustable polar blind assembly for a window as claimed in claim 17 comprises:
the transparent filter and the 45-degrees polarization filter each comprises an upper section and a lower section;
the transparent filter being partially encircled around a spool of the retractable roller mechanism;
a top edge of the 45-degrees polarization filter being positioned in between a top edge and the bottom edge of the 0-degrees polarization filter;
a bottom edge of the 45-degrees polarization filter being positioned in between the bottom edge of the 0-degrees polarization filter and the bottom edge of the 90-degrees polarization filter;
the upper section being adjacently positioned to the lower section;
the transparent filter being optical communication with the 90-degrees polarization filter and the 0-degrees polarization filter by the retractable roller mechanism;
the upper section of the 45-degrees polarization filter being optical communication with the 90-degrees polarization filter and the 0-degrees polarization filter by the retractable roller mechanism;
the lower section of the 45-degrees polarization filter being optical communication with the 90-degrees polarization filter by the retractable roller mechanism; and
the weighted base being centrally positioned in between a bottom edge of the 0-degrees polarization filter and a bottom edge of the 90-degrees polarization filter.

20. The adjustable polar blind assembly for a window as claimed in claim 17 comprises:
a top edge of the transparent filter and a top edge of the 0-degrees polarization filter being coplanar to each other;
a bottom edge of the transparent filter and a bottom edge of the 0-degrees polarization filter being coplanar to each other;
a top edge of the 45-degrees polarization filter and the bottom edge of the 0-degrees polarization filter being coplanar to each other;
a bottom edge of the 45-degrees polarization filter and the bottom edge of the 90-degrees polarization filter being coplanar to each other;
the transparent filter being optical communication with the 90-degrees polarization filter and the 0-degrees polarization filter by the retractable roller mechanism;
the 45-degrees polarization filter being optical communication with the 90-degrees polarization filter by the retractable roller mechanism; and
the weighted base being positioned adjacent to a bottom edge of the 90-degrees polarization filter.
